(19) United States
(12) Patent Application Publication
(10) Pub. No.: US 2007/0278717 A1
(43) Pub. Date: Dec. 6, 2007

(54) Thermoformable propylene polymer compositions

(76) Inventors: Leo R. Novak, Lake Jackson, TX (US); Felipe F. Martinez, Houston, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 11/891,822

(22) Filed: Aug. 13, 2007

Related U.S. Application Data
(62) Division of application No. 10/928,580, filed on Aug. 27, 2004.
Application No. 10/928,580 is a continuation-in-part of application No. 10/233,981, filed on Sep. 3, 2002, now Pat. No. 6,784,252.
(60) Provisional application No. 60/326,497, filed on Oct. 1, 2001.

(51) Int. Cl. B28B 5/02

(52) U.S. Cl. 264/294

(57) ABSTRACT

Disclosed is a process to produce thermoformed articles comprising a coupled propylene polymer composition.

### CROSS REFERENCE STATEMENT

This application is a Divisional Application of Continuation-in-Part of application Ser. No. 10/233,981 filed Sep. 3, 2002 which claims the benefit of Application No. 60/326,497 filed on Oct. 1, 2001.

### FIELD OF THE INVENTION

This invention relates to thermoformable propylene polymer compositions and fabricated articles thereof.

### BACKGROUND OF THE INVENTION

Polypropylene has been used in many applications in the form of injection molded and extruded articles, film, sheet, etc., because it is excellent in molding processability, toughness, moisture resistance, gasoline resistance, chemical resistance, has a low specific gravity, and is inexpensive. Advances in impact modification have further expanded the versatility and uses of propylene polymers. The use of propylene polymers is expanding at an increasing rate in the fields of exterior and interior automotive trims, in electrical and electrical equipment device housings and covers as well as other household and personal articles.

Automotive articles are ordinarily processed by injection molding. However, there are many components of automobiles wherein such parts are hollow and to manufacture these by injection molding is very difficult and expensive. Many such parts, particularly large parts, can conceivably be made by thermoforming provided the polymer has adequate processing properties such as high melt strength and end product properties such as toughness, especially low temperature toughness. It is known that commercially available propylene polymers for injection molding and extrusion have excellent properties, but lack a combination of good melt strength and toughness. Higher toughness and good melt strength are attributes of grades of propylene polymers with higher molecular weights, however, melt processing machine outputs tend to be inversely related to polymer molecular weights.

Attempts to modify the melt strength and toughness of propylene polymers include cross-linking or branching induced by non-selective chemistries involving free radicals using peroxides or high energy radiation. For the reaction of polypropylene with peroxides see Journal of Applied Polymer Science, Vol. 61, 1395-1404 (1996). However, this approach does not work well in actual practice as the rate of chain scission tends to dominate the limited amount of chain coupling that takes place. For radiation of polypropylene to produce long branches for producing polypropylene film see U.S. Pat. No. 5,414,027. Another method to improve melt strength of propylene polymers is taught in U.S. Pat. No. 3,336,268 wherein polypropylene is bridged with sulfonamide groups. However, no improvement was demonstrated in the ability to blow mold bridged and unbridged propylene polymers.

It would be desirable to have a tough propylene polymer composition with adequate melt strength suitable for thermoforming, especially for thermoforming large parts.

### SUMMARY OF THE INVENTION

It has now been found that sheet comprising propylene polymer compositions wherein the propylene polymer is coupled with the coupling agents according to the practice of the invention can be thermoformed into applications such as large automotive articles, recreational vehicle articles, boat articles and/or appliance covers. Preferably the propylene polymer is an impact propylene copolymer. Preferably, the coupling agent is a bis(sulfonyl azide). Further, the coupled propylene polymer composition optionally comprises one or more of a polyolefin elastomer, a thermoplastic polymer or a filler.

The invention further involves a process to thermoform articles from a coupled propylene polymer composition.

Preferably the automotive article is a seat back, a head rest, a knee bolster, glove box door, an instrument panel, a bumper facia, a bumper beam, a center console, an intake manifold, a spoiler, a side molding, a pillar, a door trim, an airbag cover, a HVAC duct, a spare tire cover, a fluid reservoir, a rear window shelf, a resonator, a trunk board or an arm rest. Preferably, recreational vehicle articles include all terrain vehicle (ATV) body panels, golf cart body panels, snow mobile cowling and body panels, personal water craft cowling and body panels, and the like. Preferably, the appliance covers include covers (sometimes referred to as side panels, enclosures, housings, and the like) for applications such as a washing machine, a dryer, a refrigerator, a freezer, an oven, a microwave, a dish washer, a furnace, an air conditioner, a television set, or a vacuum cleaner. Other applications include small appliance and power tool housings, furniture and shelves, electronic device housings, and lawn and garden tractor articles.

### DETAILED DESCRIPTION OF THE INVENTION

The thermoformed articles of the present invention are produced from a coupled propylene polymer composition. The coupled propylene polymer composition involves coupling of a propylene polymer using a coupling agent. The propylene polymer is a propylene homopolymer, preferably a propylene copolymer or most preferably an impact propylene copolymer.

The propylene polymer suitable for use in this invention is well known in the literature and can be prepared by various processes, for example, in a single stage or multiple stages, by such polymerization method as slurry polymerization, gas phase polymerization, bulk polymerization, solution polymerization or a combination thereof using a metallocene catalyst or a so-called Ziegler-Natta catalyst, which usually is one comprising a solid transition metal component comprising titanium. Particularly a catalyst consisting of, as a transition metal/solid component, a solid composition of titanium trichloride which contains as essential components titanium, magnesium and a halogen; as an organometallic component an organoaluminum compound; and if desired an electron donor. Preferred electron donors are organic compounds containing a nitrogen atom, a phosphorous atom, a sulfur atom, a silicon atom or a boron atom, and preferred are silicon compounds, ester compounds or ether compounds containing these atoms.

Propylene polymers are commonly made by catalytically reacting propylene in a polymerization reactor with appropriate molecular weight control agents. Nucleating agent may be added after the reaction is completed in order to promote crystal formation. The polymerization catalyst should have high activity and be capable of generating highly tactic polymer. The reactor system must be capable of removing the heat of polymerization from the reaction mass, so the temperature and pressure of the reaction can be controlled appropriately.

A good discussion of various polypropylene polymers is contained in Modern Plastics Encyclopedia/89, mid October 1988 Issue, Volume 65, Number 11, pp. 86-92, the entire disclosure of which is incorporated herein by reference. In general, the propylene polymer is in the isotactic form, although other forms can also be used (e.g., syndiotactic or atactic). The propylene polymer used for the present invention is a propylene homopolymer or a propylene copolymer of propylene and an alpha-olefin, preferably a C₂, or C₄ to C₂₀ alpha-olefin, for example, a random or block copolymer or preferably an impact propylene copolymer.

Examples of the C₂, and C₄ to C₂₀ alpha-olefins for constituting the propylene copolymer include ethylene, 1-butene, 1-pentene, 1-hexene, 1-heptene, 1-octene, 1-decene, 1-dodecene, 1-hexadodecene, 4-methyl-1-pentene, 2-methyl-1-butene, 3-methyl-1-butene, 3,3-dimethyl-1-butene, diethyl-1-butene, trimethyl-1-butene, 3-methyl-1-pentene, ethyl-1-pentene, propyl-1-pentene, dimethyl-1-pentene, methylethyl-1-pentene, diethyl-1-hexene, trimethyl-1-pentene, 3-methyl-1-hexene, dimethyl-1-hexene, 3,5,5-trimethyl-1-hexene, methylethyl-1-heptene, trimethyl-1-heptene, dimethyloctene, ethyl-1-octene, methyl-1-nonene, vinylcyclopentene, vinylcyclohexene and vinylnorbornene, where alkyl branching position is not specified it is generally on position 3 or higher of the alkene.

For random or block propylene copolymers, the alpha-olefin is present in an amount of not more than 15 weight percent, preferably not more than 12 weight percent, even more preferably not more than 9 weight percent and most preferably not more than 7 weight percent.

Impact propylene copolymers are commercially available and are well known within the skill in the art, for instance, as described by E. P. Moore, Jr in Polypropylene Handbook, Hanser Publishers, 1996, page 220-221 and U.S. Pat. Nos. 3,893,989 and 4,113,802. The term “impact propylene copolymer” is used herein to refer to heterophasic propylene copolymers where polypropylene is the continuous phase and an elastomeric phase is dispersed therein. Those of skill in the art recognize that this elastomeric phase may also contain crystalline regions, which for purposes of the current invention are considered part of the elastomeric phase. The impact propylene copolymer may be polypropylene and an elastomer physically blended, preferably the impact propylene copolymers result from an in-reactor process. Usually the impact propylene copolymers are formed in a dual or multi-stage process, which optionally involves a single reactor with at least two process stages taking place therein, or optionally multiple reactors.

The continuous phase of the impact propylene copolymer typically will be a propylene homopolymer or a random propylene copolymer, more typically a propylene homopolymer. The continuous phase of the impact propylene copolymer may be made using Ziegler-Natta catalyst, constrained geometry catalyst, metallocene catalyst, or any other suitable catalyst system. Preferably, the catalyst(s) yield stereo-regular polymers, preferably isotactic. When the propylene polymer making up the continuous phase is a propylene homopolymer, the crystallinity of the propylene polymer, as determined by differential scanning calorimetry, is preferably equal to or greater than about 50 percent, more preferably equal to or greater than about 62 percent, even more preferably equal to or greater than about 75 percent, even more preferably equal to or greater than about 90 percent, even more preferably equal to or greater than about 95 percent, and most preferably equal to or greater than about 98 percent. The methods for determining percent crystallinity using a differential scanning calorimetry are known to one skilled in the art.

Preferably the propylene polymer making up the continuous phase is a high crystalline propylene homopolymer having equal to or less than 1.5 weight percent atactic propylene polymer as determined by xylene solubles, more preferably having equal to or less than 1.2 weight percent atactic propylene polymer, even more preferably having equal to or less than 1 weight percent atactic propylene polymer, and most preferably having equal to or less than 0.7 weight percent atactic propylene polymer wherein weight percent is based on the total weight of the propylene polymer.

The elastomeric phase comprises propylene and one or more alpha olefins, preferably ethylene. The elastomeric phase may be made using constrained geometry catalyst, Ziegler-Natta catalyst, metallocene catalyst, or any other suitable catalyst.

When the continuous phase of the impact propylene copolymer is a propylene homopolymer and the elastomeric phase is comprised of a copolymer or terpolymer containing monomer units derived from ethylene, the impact propylene copolymer preferably contains an amount equal to or greater than about 5 weight percent, more preferably equal to or greater than about 7 weight percent, most preferably equal to or greater than about 9 weight percent —CH₂CH₂— units derived from ethylene monomer based on the total weight of the impact propylene copolymer. Preferably, such an impact propylene copolymer contains less than about 30 weight percent, more preferably less than about 25 weight percent, most preferably less than about 20 weight percent —CH₂CH₂-units derived from ethylene monomer based on the total weight of the impact propylene copolymer.

Advantageously, the impact propylene copolymers used for the invention have an elastomeric phase in an amount equal to or greater than about 10 weight percent, preferably equal to or greater than about 15 weight percent, more preferably equal to or greater than about 20 weight percent based on the total weight of the impact propylene copolymer. Preferably, the elastomeric phase is less or equal to about 70 weight percent, more preferably less than or equal to about 40 weight percent, most preferably less than or equal to about 25 weight percent based on the total weight of the impact propylene copolymer.

The propylene polymer is employed in amounts equal to or greater than about 30 parts by weight, preferably equal to or greater then about 40 parts by weight, more preferably equal to or greater than about 50 parts by weight, even more preferably equal to or greater than about 60 parts by weight and most preferably equal to or greater than about 70 parts by weight based on the weight of the coupled propylene polymer composition. In general, the propylene polymer is used in amounts less than or equal to about 100 parts by weight, preferably less than or equal to about 95 parts by weight, more preferably less than or equal to about 90 parts by weight, even more preferably less than or equal to about 85 parts by weight and most preferably less than or equal to 80 parts by weight based on the weight of the coupled propylene polymer composition.

For the purpose of coupling, the propylene polymer is reacted with a polyfunctional compound which is capable of insertion reactions into carbon-hydrogen bonds. Compounds having at least two functional groups capable of insertion into the carbon-hydrogen bonds of CH, CH₂, or CH₃ groups, both aliphatic and aromatic, of a polymer chain are referred to herein as coupling agents. Those skilled in the art are familiar with carbon-hydrogen insertion reactions and functional groups capable of such reactions, for instance carbenes and nitrenes. Examples of chemical compounds that contain a reactive group capable of forming a carbene group include, for example, diazo alkanes, geminally-substituted methylene groups, and metallocarbenes. Examples of chemical compounds that contain reactive groups capable of forming nitrene groups, include, but are not limited to, for example, alkyl and aryl azides (R—N₃), acyl azides (R—C(O)N₃), azidoformates (R—O—C(O)—N₃), sulfonyl azides (R—SO₂—N₃), phosphoryl azides ((RO)₂—(PO)—N₃), phosphinic azides (R₂—P(O)—N₃) and silyl azides (R₃—Si—N₃). It may be necessary to activate a coupling agent with heat, sonic energy, radiation or other chemical activating energy, for the coupling agent to be effective for coupling propylene polymer chains.

The preferred coupling agent is a sulfonyl azide, more preferably a bis(sulfonyl azide). Examples of sulfonyl azides useful for the invention are described in WO 99/10424. Sulfonyl azides include such compounds as 1,5-pentane bis(sulfonyl azide), 1,8-octane bis(sulfonyl azide), 1,10-decane bis(sulfonyl azide), 1,10-octadecane bis(sulfonyl azide), 1-octyl-2,4,6-benzene tris(sulfonyl azide), 4,4′-diphenyl ether bis(sulfonyl azide), 1,6-bis(4′-sulfonazidophenyl)hexane, 2,7-naphthalene bis(sulfonyl azide), and mixed sulfonyl azides of chlorinated aliphatic hydrocarbons containing an average of from 1 to 8 chlorine atoms and from 2 to 5 sulfonyl azide groups per molecule, and mixtures thereof. Preferred sulfonyl azides include 4,4′ oxy-bis-(sulfonylazido)benzene, 2,7-naphthalene bis(sulfonyl azido), 4,4′-bis(sulfonyl azido)biphenyl, 4,4′-diphenyl ether bis(sulfonyl azide) and bis(4-sulfonyl azidophenyl)methane, and mixtures thereof.

Sulfonyl azides are commercially available or are conveniently prepared by the reaction of sodium azide with the corresponding sulfonyl chloride, although oxidation of sulfonyl hydrazines with various reagents (nitrous acid, dinitrogen tetroxide, nitrosonium tetrafluoroborate) has been used.

One skilled in the art knows that an effective amount of coupling agent is dependent on the coupling agent selected and the average molecular weight of the propylene polymer. Typically, the lower the molecular weight of the propylene polymer, the more coupling agent needed. An effective amount of coupling agent is an amount sufficient to result in adequate melt strength for thermoforming, but less than a cross-linking amount, that is an amount sufficient to result in less than about 10 weight percent gel in the coupled propylene polymer as measured by ASTM D2765-procedure A. When a sulfonyl azide is used as a coupling agent, generally, an effective amount is equal to or greater than about 50 parts per million (ppm), preferably equal to or greater than about 75 ppm, more preferably equal to or greater than about 100 ppm and most preferably equal to or greater than 150 ppm by weight based on the weight of the propylene polymer. Formation of cross-linked propylene polymer is to be avoided, therefore the amount of bis(sulfonyl azide) is limited to equal to or less than 2000 ppm, preferably equal to or less than 1500 ppm and more preferably equal to or less than 1300 ppm by weight based on the weight of the propylene polymer.

Optionally, the propylene polymer compositions of the present invention may comprise an elastomer. Elastomers are defined as materials which experience large reversible deformations under relatively low stress. Elastomers are typically characterized as having structural irregularities, non-polar structures, or flexible units in the polymer chain. Preferably, an elastomeric polymer can be stretched to at least twice its relaxed length with stress and after release of the stress returns to approximately the original dimensions and shape. Some examples of commercially available elastomers include natural rubber, polyolefin elastomers (POE), chlorinated polyethylene (CPE), silicone rubber, styrene/butadiene (SB) copolymers, styrene/butadiene/styrene (SBS) terpolymers, styrene/ethylene/butadiene/styrene (SEBS) terpolymers and hydrogenated SBS or SEBS.

Preferred elastomers are polyolefin elastomers. Suitable polyolefin elastomers for use in the present invention comprise one or more C₂ to C₂₀ alpha-olefins in polymerized form, having a glass transition temperature (T_{g}) less than 25° C., preferably less than 0° C. T_{g} is the temperature or temperature range at which a polymeric material shows an abrupt change in its physical properties, including, for example, mechanical strength. T_{g} can be determined by differential scanning calorimetry. Examples of the types of polymers from which the present polyolefin elastomers are selected include polyethylene and copolymers of alpha-olefins, such as ethylene and propylene (EPM), ethylene and 1-butene, ethylene and 1-hexene or ethylene and 1-octene copolymers, and terpolymers of ethylene, propylene and a diene comonomer such as hexadiene or ethylidene norbornene (EPDM) and ethylene, propylene and a C₄ to C₂₀ alpha-olefin.

A preferred polyolefin elastomer is one or more substantially linear ethylene polymer or one or more linear ethylene polymer (S/LEP), or a mixture of one or more of each. Both substantially linear ethylene polymers and linear ethylene polymers are well known. Substantially linear ethylene polymers and their method of preparation are fully described in U.S. Pat. No. 5,272,236 and U.S. Pat. No. 5,278,272 and linear ethylene polymers and their method of preparation are fully disclosed in U.S. Pat. No. 3,645,992; U.S. Pat. No. 4,937,299; U.S. Pat. No. 4,701,432; U.S. Pat. No. 4,937,301; U.S. Pat. No. 4,935,397; U.S. Pat. No. 5,055,438; EP 129,368; EP 260,999; and WO 90/07526 the disclosures of which are incorporated herein by reference.

If present, the elastomer is employed in amounts of equal to or greater than about 5 parts by weight, preferably equal to or greater than about 10 parts by weight, more preferably equal to or greater than about 15 parts by weight and most preferably equal to or greater than about 20 parts by weight based on the weight of the coupled propylene polymer composition. In general, the elastomer is used in amounts less than or equal to about 70 parts by weight, preferably less than or equal to about 60 parts by weight, more preferably less than or equal to about 50 parts by weight, even more preferably less than or equal to about 40 parts by weight and most preferably 30 parts by weight based on the weight of the coupled propylene polymer composition.

Optionally, one or more additional thermoplastic polymer may be blended with the coupled propylene polymer provided the desired thermoforming properties in the resulting coupled propylene polymer composition are achieved. Examples of additional thermoplastic polymers include any of the coupled or uncoupled propylene polymers described above for this invention including high crystalline polypropylene, high crystalline propylene copolymers with from about 0.5 percent to about 1 percent ethylene, or more preferably from about 0.5 percent to about 2 percent ethylene, or mini-random propylene/ethylene copolymers; functionalized polypropylene, such as maleated polypropylene or polypropylene with carboxylic acid moieties; polyethylene, such as high density polyethylene (HDPE), low density polyethylene (LDPE), linear low density polyethylene (LLDPE), ultra low density polyethylenes (ULDPE) and very low density polyethylene (VLDPE); interpolymers of ethylene with a vinyl aromatic, such as styrene; ethylene-vinyl acetate copolymer (EVA), ethylene-ethyl acetate copolymer (EEA), ethylene acrylic acid (EAA), polyethylene graft maleic anhydride (PE-g-MAH), polystyrene; polycyclohexylethane; polyesters, such as polyethylene terephthalate; syndiotatic polypropylene; syndiotactic polystyrene; polyamides; and mixtures thereof.

If present, the additional thermoplastic polymer is employed in amounts equal to or greater than about 5 parts by weight, preferably equal to or greater than about 10 parts by weight, more preferably equal to or greater than about 15 parts by weight and most preferably equal to or greater than about 20 parts by weight based on the weight of the coupled propylene polymer composition. In general, the additional polymer is used in amounts less than or equal to about 70 parts by weight, preferably less than or equal to about 60 parts by weight, more preferably less than or equal to about 50 parts by weight, even more preferably less than or equal to about 40 parts by weight and most preferably 30 parts by weight based on the weight of the coupled propylene polymer composition.

Optionally, the propylene polymer compositions of the present invention may further comprise mineral fillers such as calcium carbonate, talc, clay, mica, wollastonite, hollow glass beads, titaninum oxide, silica, carbon black, glass fiber or potassium titanate. Preferred fillers are talc, wollastonite, clay, cation exchanging layered silicate material or mixtures thereof. Talcs, wollastonites, and clays are generally known fillers for various polymeric resins. See for example U.S. Pat. No. 5,091,461 and U.S. Pat. No. 3,424,703; EP 639,613 A1; and EP 391,413, where these materials and their suitability as filler for polymeric resins are generally described.

Examples of preferred cation exchanging layered silicate materials, sometimes referred to as nanofillers, include biophilite, kaolinite, dickalite or talc clays; smectite clays; vermiculite clays; mica; brittle mica; fluoromica; Sepiolite; Magadiite; Kenyaite; Octosilicate; Kanemite; and Makatite. Preferred cation exchanging layered silicate materials are smectite clays, including montmorillonite, bidelite, saponite and hectorite.

The desired amount of filler will depend on the filler, the propylene polymer and the application, but usually, the filler is employed in an amount equal to or greater than about 0.01 parts by weight, preferably equal to or greater than about 0.1 parts by weight, more preferably equal to or greater than about 1 parts by weight, even more preferably equal to or greater than about 5 parts by weight, and most preferably equal to or greater than about 10 parts by weight based on the total weight of the coupled propylene polymer composition. Usually it has been found sufficient to employ an amount of filler equal to or less than about 50 parts by weight, preferably equal to or less then about 40 parts by weight, more preferably equal to or less than about 30 parts by weight, more preferably equal to or less than about 25 parts by weight, more preferably up to and including about 20 parts by weight, and most preferably up to and including about 15 parts by weight based the weight of the coupled propylene polymer composition.

Additionally, it is believed that in some instances nucleating agents and/or clarifying agents may preferably be utilized with the practice of the invention. Examples of nucleating agents include metal salts of an aromatic or aliphatic carboxylic acid, such as aluminum benzoate, sodium benzoate, aluminum p-t-butylbenzoate, sodium adipate, sodium thiophenecarboxylate and sodium pyrrolecarboxylate. Metal salts of an organic phosphoric acid are also preferred as the nucleating agent. Additional nucleating agents and their use are fully described in U.S. Pat. No. 6,153,715 which is incorporated herein by reference.

Various additives are optionally incorporated in the coupled propylene polymer composition such as, pigments, antioxidants, acid scavengers, ultraviolet absorbers, neutralizers, slip agents, antiblock agents, antistatic agents, waxes, flame retardants, processing aids, extrusion aids, and other additives within the skill in the art used in combination or alone. Effective amounts are known in the art and depend on parameters of the composition and conditions to which they are exposed.

The coupling reaction is implemented via reactive extrusion or any other method which is capable of mixing the coupling agent with the propylene polymer and adding sufficient energy to cause a coupling reaction between the coupling agent and the propylene polymer. Preferably, the process is carried out in a single vessel such as a melt mixer or a polymer extruder, such as described in U.S. patent application Ser. No. 09/133,576 filed Aug. 13, 1998 which is incorporated by reference herein in its entity. The term extruder is intended to include its broadest meaning and includes such devices as a device which extrudes pellets as well as an extruder which produces sheet. An extruder which produces a multilayer sheet by coextrusion is also with in the scope of the present invention.

The reaction vessel preferably has at least two zones capable of different temperatures into which a reaction mixture would pass, the first zone advantageously being at a temperature at least the softening temperature of the propylene polymer and preferably less than the decomposition temperature of the sulfonyl azide and the second zone being at a temperature, sometimes referred to as melt process temperature, sufficient for decomposition of the sulfonyl azide. The first zone is preferably at a temperature sufficiently high to soften the propylene polymer and allow it to combine with the sulfonyl azide through distributive mixing, preferably to a substantially uniform admixture. Preferably, the propylene polymer admixture comprising the sulfonyl azide is exposed to a profile of temperature in the first zone ranging from about 50° C. to about 220° C., preferably about 160° C. to about 200° C. and the melt process temperature in the second zone is from about 200° C. to about 285° C., preferably from about 220° C. to about 255° C.

Sheet manufactured from compositions of the present invention preferably have a flexural modulus according to ISO 178 of equal to or greater than about 220,000 pounds per square inch (psi), a notched Izod impact strength according to ISO 180/1A at 0° C. of equal to or greater than about 4 foot-pound per inch (ft-lb/in.) and at 23° C. of equal to or greater than about 10 ft-lb/in., a heat deflection temperature according to ISO 75 of equal to or greater than about 10° C., a 60 degree gloss according to ISO 2813 of equal to or greater than about 80, or combinations thereof.

The sheet of the present invention comprises one or more layer wherein at least one layer comprises the coupled propylene polymer composition of the present invention. Coupled propylene polymer compositions of the present invention are thermoplastic and formed into single or multilayer sheet by any conventional process, preferably by sheet extrusion. The thickness of the sheet is only limited by the equipment used to make it and form it into an article. However, the sheet of the present invention is preferably equal to or greater than about 0.1 mm, more preferably equal to or greater than about 0.5 mm and most preferably equal to or greater than about 1 mm in thickness. Generally, the sheet of the present invention is preferably equal to or less than about 20 mm, more preferably equal to or less than about 18 mm and most preferably equal to or less than about 15 mm in thickness.

If the sheet of the present invention comprises two or more layers, the coupled propylene polymer composition of the present invention may comprise one or more of the layers. In other words, the propylene polymer composition of the present invention is the base layer and/or the cap layer and/or any layer between the base layer and the cap layer. For a multi layer sheet, the base, or thickest, layer is preferably equal to or greater than about 0.5 mm and most preferably equal to or greater than about 1 mm in thickness. Generally, the base layer of a multilayer sheet of the present invention is preferably equal to or less than about 20 mm, more preferably equal to or less than about 18 mm and most preferably equal to or less than about 15 mm in thickness. Any subsequent layers in a multilayer sheet are independently preferably equal to or greater than about 0.1 mm, more preferably equal to or greater than about 0.2 mm and most preferably equal to or greater than about 0.5 mm. Any subsequent layers in a multilayer sheet are independently preferably equal to or less than about 2 mm, more preferably equal to or less than about 1.8 mm and most preferably equal to or less than about 1.5 mm.

If the sheet of the present invention comprises more than one layer, the layer(s) not comprising the coupled propylene polymer of the present invention are not limited in composition other than they must be thermoplastic polymer(s) compatible with, in other words will not delaminate from, the layer(s) comprising the coupled propylene polymer composition. For instance, compatible thermoplastic polymer(s) may be transparent translucent and/or opaque. They include functionalized polypropylene, such as maleated polypropylene or polypropylene with carboxylic acid moieties; polyolefins such as HDPE, LDPE, LLDPE, ULDPE, VLDPE; interpolymers of ethylene with a vinyl aromatic, such as styrene, EVA, EEA, EAA, PE-g-MAH, polystyrene; polycyclohexylethane; polyesters, such as polyethylene terephthalate; syndiotatic polypropylene; syndiotactic polystyrene; polyamides; and mixtures thereof polyethylene, polyethylene copolymer with a C₃ to C₂₀ alpha olefin, polypropylene, or mixtures thereof. The compatible thermoplastic polymer(s) may contain fillers and/or additives commonly used in such polymers such as pigments, UV stabilizers, impact modifiers, slip agents, and the like. The multilayer sheet may further comprise tie layers or adhesive layers between the polymer layers comprising the sheet. The layer(s) not comprising the coupled propylene polymer of the present invention may also comprise scrap, regrind, and/or recycled material.

The formed article of the present invention may be manufactured by thermoforming a sheet comprising the abovementioned coupled propylene polymer composition through the use of conventional machinery employing conventional conditions. There are a number of thermoforming techniques in use, but all are basically variations of two simple processes in which a heated sheet is moved by (1) air in the form of an applied vacuum and/or pressurized air, or (2) mechanical draw assists which force the sheet into a mold to produce the desired contoured or shaped article. In many cases the two processes are combined to result in a wide variety of procedures to make thermoformed articles. For example, thermoforming methods within the scope of the present invention include, but are not limited to, straight forming, drape forming, snapback forming, reverse-draw forming, plug-assist forming, plug-assist/reverse draw forming, air-slip forming/plug-assist, air-slip forming, matched tool forming, twin-sheet forming, and the like.

The thermoforming process includes heating a sheet until it softens or starts to sag, after which one or more of vacuum, air pressure, and/or mechanical draw assist is applied and the heated sheet is drawn into a female mold, sometimes referred to as die, drawn over a male mold, or the two molds are used together to form an article, the formed article is cooled, removed from the mold, and trimmed as necessary.

The sheet temperature for thermoforming a sheet of the coupled propylene polymer of the present invention is less than or equal to about 190° C., preferably less than or equal to about 180° C. and more preferably less than or equal to about 175° C. Further, the sheet temperature for thermoforming a sheet of the coupled propylene polymer of the present invention is greater than or equal to about 160° C., preferably greater than or equal to about 165° C. and more preferably greater than or equal to about 170° C.

Adequate polymer melt strength is necessary for producing acceptable thermoformed articles, especially large articles with sections having a deep draw. Preferably, sheet made form the coupled propylene polymers of the present invention have a draw ratio of at least 3:1, preferably 2.5:1 and most preferably 2:1.

### EXAMPLES

A 50:50 talc:propylene polymer concentrate (referred to hereinafter as TALC:PP CONCENTRATE”) is compounded on a Farrel Continuous Mixer (FCM) CP-250 having a mixing section and an extruding section. The propylene polymer used is a high crystalline propylene polymer having a density of about 0.9 grams per cubic centimeter (g/cc) and a melt flow rate (MFR) of about 1.5 grams per 10 minutes (g/10 min.) determined at 230° C. under an applied load of 2.16 kilograms (kg) and is available as INSPIRE™ D207.01 Performance Polymer available from The Dow Chemical Company and is hereinafter referred to as “PP-1”. The talc is commercially available as JETFIL™ 700C from Luzenac America having a median particle size of 1.5 microns and is hereinafter referred to as “TALC”. The following are the compounding conditions for the mixing section: Barrel temperature profile: 175° C., 180° C. and 210° C.; Screw speed is 850 revolutions per minute (RPM), Rate is 500 pounds per hour (lb/hr.); and Melt temperature 225° C. The extrudate from the continuous mixer is fed directly into the throat of the single screw extruder having a screw length/diameter of 11:1, a compression ratio of 3:1 and 100 RPM. The extruder section operated under the following temperatures: Barrel rear 180° C., forward 200° C.; Adapter: 220° C. and Die: 220° C. The extrudate from the single screw extruder is cooled in the form of strands and comminuted in a strand chopper as pellets.

The talc:PP concentrate pellets are blended with additional components to prepare Examples 1 to 9. The components of Examples 1 to 9 are dry blended then extruded into 145 mil sheet on a Welex monolayer/co-extrusion sheet line having two extruders. Extruder B contains a standard polypropylene 3.5 inch polypropylene screw with a length to diameter (UD) ratio of 30:1 followed by a gear melt pump. Extruder A is a two inch co-extruder with a L/D of 24:1 designed to make thin cap layers on one or both sides of the sheet from extruder B. Both extruders feed a multi-layer feed block capable of making 1, 2, or 3 (A/B, B/A, OR A/B/A) layer co-extruded structures. The line is fitted with a Welex 34 inch R-100 die, a sheet take-off, and a fixed shaft winder. Extrusion conditions are controlled by a Welex Ultima III Process Control. The following are the process conditions to make Examples 1 to 9: Zone 1 to 5 temperatures are about 396° F., 450° F., 382° F., 445° F., and 445° F.; Vent zone temperature is about 108° F.; Melt temperature is about 478° F.; Main head pressure is about 295 pounds per square inch (psi); Output rate is about 318 pounds per hour; and Die feed block and zone temperatures are all about 450° F. The 145 mil sheet measures 30 inches wide and is cut into lengths of 25 inches.

The resulting sheet is thermoformed on an AAA melt phase cut sheet thermoformer with two side heating. A male mold in the shape of a truncated pyramid having a rectangular base measuring about 8 inches by 10 inches at the base, 6 inches by 8 inches at the top, and about 4 inches deep is used. The draw ratio is about 3:1 and the thermoformed part has an average thickness of from about 50 to about 70 mil. The sheet is heated to a semi-molten state in the oven using top and bottom ceramic heaters for 145 seconds at 50% heat until a surface temperature of 340° F. to 350° F. is measure by an infrared (IR) gun. The semi-molten sheet is moved to the forming station where the top vacuum box is pressed against the gloss surface. Vacuum is applied for 1.0-1.5 seconds from the top or until forming a bubble slightly smaller than the male mold. The mold is then pushed from the bottom into the molten bubble to produce the final forming of the sheet. The vacuum is switched to the mold side to force the molten sheet against the mold surface and conform to its shape. The formed part is extracted from the mold and cooled at about 80-100° C. per minute until the part is solid enough to be extracted.

The formulation content of Examples 1 to 9 is given in Table 1 below in parts by weight of the total composition. In Table 1:

“PP 2” is a high crystalline propylene polymer having a density of about 0.9 g/cc, a MFR of about 3.0 g/10 min. determined at 230° C. under an applied load of 2.16 kg and is available as INSPIRE D404.01 Performance Polymer available from The Dow Chemical Company;

“PP 3” is an impact propylene copolymer comprising about 18 percent (%) ethylene/octene rubber having a density of about 0.9 g/cc, a MFR of about 1.9 g/10 min. determined at 230° C. under an applied load of 2.16 kg and is available as INSPIRE D117.00 Performance Polymer available from The Dow Chemical Company;

“PP 4” is a coupled impact copolymer polypropylene wherein an impact propylene copolymer comprising about 14% ethylene/propylene rubber is used as the base resin. The copolymer has a density of about 0.9 g/cc and a MFR of about 1.2 g/10 min. determined at 230° C. under an applied load of 2.16 kg. The base resin, about 2960 parts per million (ppm) IRGANOX™ 1010 (phenolic antioxidant commercially available from Ciba Geigy), 600 ppm IRGAFOS™ 168 (phosphate antioxidant commercially available form Ciba Geigy), and about 200 parts per million 4,4′ oxy-bis-(sulfonylazido)benzene are feed into a Werner and Pfleiderer ZSK40 twin screw extruder at a feed rate of 250 pounds per hour, a screw speed of 300 rpm and with a target temperature profile of 180/190/200/200/210/220/230/240/230/240/240° C. (from feed inlet to die). The extrudate is comminuted to pellets as the coupled impact copolymer propylene.

PP-4 has a crystallinity of about 62 weight percent as determined on a TA Instrument 2910 DSC apparatus by the following procedure: A small sample (milligram size) of the propylene polymer is sealed into an aluminum DSC pan. The sample is placed into a DSC cell with a 25 centimeter per minute nitrogen purge and cooled to about −100° C. A standard thermal history is established for the sample by heating at 10° C. per minute to 225° C. The sample is then cooled to about −100° C. and reheated at 10° C. per minute to 225° C. The observed heat of fusion (ΔH_{observed}) for the second scan is recorded. The observed heat of fusion is related to the degree of crystallinity in weight percent based on the weight of the polypropylene sample by the following equation:

$$Crystallinity , \% = \frac{Δ {H}_{observed}}{Δ {H}_{isotactic PP}} \times 100$$

where the heat of fusion for isotactic polypropylene (ΔH_{isotactic PP}), as reported in B. Wunderlich, Macromolecular Physics, Volume 3, Crystal Melting, Academic Press, New Your, 1980, p 48, is 165 Joules per gram (J/g) of polymer. The standard thermal history is established by allowing the sample to cool from 225° C. to room temperature and then cooling the sample from room temperature to −100° C. with liquid nitrogen; and

“S/LEP” is a substantially linear ethylene/octene copolymer available as AFFINITY™ EG 8150 from The Dow Chemical Company having a density of approximately 0.868 g/cm³, a melt flow rate of 0.5 g/10 min. determined according to ASTM D 1238 at 190° C. and an applied load of 2.16 kg, and a CBDI of greater than 50.

Physical properties are measured on test specimens prepared from the extruded sheet. The following physical property tests are run on Examples 1 to 9 and the results of these tests are shown in Table 1:

“Flexural Properties” are determined in accordance with ASTM D 790. Testing is performed using a Series 9 Automated Testing System, Model 4501 mechanical tester. Flexural Modulus results are reported in 10⁵ pounds per square inch (10⁵ psi) and Flexural Strength results are reported in psi;

“HDUL” heat distortion under load was determined on a Ceast HDT 300 Vicat machine in accordance to ASTM D 648-82(88) where test specimens were unannealed and tested under an applied pressure of 66 psi; and

“Notched Izod” is determined according to ASTM D 256 at 23° C. and 0° C. The specimens are notched with a notcher to give a 0.100 inch ±0.002 inch radius notch. A standard Izod impact testing unit equipped with a cold temperature chamber and a 10 foot-pound (ft-lb) free falling hammer is used. Results are reported in foot-pounds per inch (ft-lb/in).

TABLE 1

| | Example | | | | | | | | |
|---|---|---|---|---|---|---|---|---|---|
| | 1 | 2 | 3 | 4 | 5 | 6 | 7 | 8 | 9 |
| COMPOSITION | | | | | | | | | |
| TALC: PP CONCENTRATE | 10 | 10 | 20 | 20 | 40 | 10 | 10 | 20 | 20 |
| PP-1 | 40 | | 30 | | | | | | |
| PP-2 | | 40 | | 30 | 10 | | 20 | 20 | 5 |
| PP-3 | | | | | | 42 | | | |
| PP-4 | 30 | 30 | 30 | 30 | 30 | 35 | 50 | 40 | 65 |
| S/LEP | 20 | 20 | 20 | 20 | 20 | 13 | 20 | 20 | 10 |
| PROPERTIES | | | | | | | | | |
| Flex Modulus, 10⁵ psi | 1.78 | 1.89 | 2.33 | 2.37 | 2.74 | 2.07 | 1.76 | 2.13 | 2.44 |
| HDUL, ° C. | 103.5 | | 112.7 | | | 109.6 | 96.9 | 110.4 | 119 |
| Notched Izod, ft-lb/in | | | | | | | | | |
| 23° C. | 16.0 | 15.4 | 15.5 | 14.8 | 15.3 | 14.7 | 15.5 | 15.8 | 15.1 |
| 0° C. | 14.9 | 13.5 | 12.9 | 11.4 | 12.0 | 11.7 | 14.7 | 14.1 | 10.8 |

Examples 10 to 16 are co-extruded sheet comprising a core layer and a cap layer having a total thickness of 4 mm. The base stock for the core layers of Examples 10 to 16 is prepared on the FCM CP-250 described hereinabove. The components are dry blended prior to melt blending in the FCM CP-250. The following are the compounding conditions for the mixing section: Barrel temperature profile: 100° C., 220° C. and 220° C.; Screw speed is 350 RPM, Rate is 300 lb/hr.; and Melt temperature 210° C. The extrudate from the continuous mixer is fed directly into the throat of the single screw extruder having a screw length/diameter of 11:1, a compression ratio of 3:1 and 35 RPM. The extruder section operated under the following temperatures: Barrel rear 220° C., forward 220° C.; Adapter: 220° C. and Die: 220° C. The extrudate from the single screw extruder is cooled in the form of strands and comminuted in a strand chopper into pellets.

The components for the cap layer for Examples 10 to 16 are first dry blended then melt blended in a Werner-Pfleiderer ZSK 40 mm twin screw vented extruder with barrel temperatures from 208° C. at the hopper to 220° C., a melt temperature of 217° C. and a rate of 225 lb/hr. The extrudate from the twin screw extruder is cooled in the form of strands and comminuted in a strand chopper into pellets.

The core layer pellets and cap layer pellets are dried at 71° C. for four hours before co-extruding into sheet. The core layer is extruded using a 2.5 inch HPM single screw extruder with a general purpose 3.5:1 compression ratio screw. The barrel temperatures are set starting at 181° C. at the hopper and increasing to 230° C. at the extruder exit. The cap layer is extruded using a 1.25 inch Killion single screw extruder with a standard polyolefin screw. The barrel temperatures are set starting at 203° C. at the hopper and increasing to 220° C. at the extruder exit. Both extruders feed a co-extrusion feed-block set for a two layer laminate configuration. Feed-block temperatures are controlled at 245° C. A 28 inch coat-hanger type design sheet die is used and with a 0.165 inch die gap. A 28 inch width Sterling horizontal three roll stack operating with a roll gap of 0.160 in is used for take-off. Roll temperatures are controlled at: Front roll, 72° C.; Middle roll, 100° C., and Back roll, 94° C.

The formulation content of Examples 10 to 16 is given in Table 2 below in parts by weight of the total composition. In Table 2:

“Black” is a carbon black concentrate comprising 64% carbon black in a propylene homopolymer having a MFR of 12 g/10 min. available from Modern Dispersion, Inc. as MDI Black Concentrate PP-535.

Physical properties are measured on test specimens prepared from the co-extruded sheet. The following physical property tests are run on Examples 10 to 16 and the results of these tests are shown in Table 1:

“Specific Gravity” is determined according to ASTM D 792;

“Gloss @ 20°” is performed according to ASTM D 955 and results are reported in %;

“Gloss @ 60°” is performed according to ASTM D 630 B and results are reported in %;

“Dart” instrumented impact is determined according to ASTM D 3763 at 73° C., Peak Energy and Total Energy are reported in inch pounds (in/lbs);

“VICAT” softening point is measured according to ASTM D 1525 and results are reported in ° F.

TABLE 2

| | Example | | | | | | |
|---|---|---|---|---|---|---|---|
| | 10 | 11 | 12 | 13 | 14 | 15 | 16 |
| BASE STOCK | | | | | | | |
| PP-2 | 45 | 45 | 45 | 45 | 45 | 45 | 45 |
| PP-4 | 30 | 30 | 30 | 30 | 30 | 30 | 30 |
| S/LEP | 20 | 20 | 20 | 20 | 20 | 20 | 20 |
| TALC | 5 | 5 | 5 | 5 | 5 | 5 | 5 |
| Black | 4 | 4 | 4 | 4 | | | |
| CAP LAYER | | | | | | | |
| Thickness, mil | 20 | 10 | 20 | 10 | 10 | 20 | 20 |
| PP-2 | 100 | 100 | 96 | 96 | 96 | 96 | 100 |
| Black | | | 4 | 4 | 4 | 4 | |
| PROPERTIES | | | | | | | |
| Specific Gravity | 0.93 | 0.94 | 0.94 | 0.93 | 0.93 | 0.93 | 0.93 |
| Gloss @ 20° | 78 | 78 | 71 | 70 | 69 | 69 | 76 |
| Gloss @ 60° | 87 | 88 | 86 | 87 | 86 | 86 | 86 |
| Flexural properties | | | | | | | |
| Cap Layer | | | | | | | |
| Strength, psi | 5750 | 6000 | 5720 | 5490 | 5670 | 6070 | 5430 |
| Modulus, 10⁵ psi | 2.52 | 2.67 | 2.42 | 2.36 | 2.53 | 2.71 | 2.25 |
| Core Layer | | | | | | | |
| Strength, psi | 6760 | 5820 | 5860 | 6200 | 5480 | 5640 | 4550 |
| Modulus, 10⁵ psi | 3.01 | 2.62 | 2.58 | 2.85 | 2.46 | 2.37 | 1.90 |
| Dart | | | | | | | |
| Cap Layer | | | | | | | |
| Peak, in · lbs | 225 | 237 | 158 | 161 | 165 | 165 | 206 |
| Total, in · lbs | 436 | 457 | 278 | 291 | 278 | 277 | 328 |
| VICAT | | | | | | | |
| Cap Layer, ° F. | 293 | 290 | 292 | 292 | 291 | 291 | 291 |
| Core Layer, ° F. | 300 | 295 | 301 | 298 | 298 | 299 | 298 |

The resulting co-extruded sheet from Examples 10 to 16 is thermoformed on a manual feed AAA thermoformer with two side heating equipped with a lower platen mounted plug mold and a top platen mounted vacuum box to allow pre-billow, vacuum snapback forming. A block shaped male mold having a nominal 230 mm width by 165 mm depth by 100 mm height is used. All vertical sides have about a 10 draft and all edges and corners have a 6 mm radius. Sheet heating cycle dwell times range from about 145 seconds to 170 seconds. Draw rations of about 2.5:1 are achieved.

What is claimed is:

1. A process for thermoforming a coupled propylene polymer composition into an article comprising the steps of
i extruding a coupled propylene polymer comprising a coupled propylene polymer, a substantially linear ethylene polymer and/or a linear ethylene polymer and optionally a thermoplastic polymer and/or a filler in an extruder through a sheet die,
ii forming a sheet,
iii heating the sheet,
iv forcing the heated sheet into a mold and
v yielding a thermoformed article with the desired contour or shape.

2. The process of claim 1 wherein the propylene polymer coupling reaction takes place in the same extruder that produces the sheet.

3. The process of claims 1 or 2 wherein the article is an automotive article, a recreational vehicle article, a boat article or an appliance cover.

4. The process of claim 3 wherein the automotive article is a seat back, a head rest, a knee bolster, glove box door, an instrument panel, a bumper facia, a bumper beam, a center console, an intake manifold, a spoiler, a side molding, a pillar, a door trim, an airbag cover, a HVAC duct, a spare tire cover, a fluid reservoir, a rear window shelf, a resonator, a trunk board or an arm rest.

5. The process of claim 3 wherein the appliance cover is for a washing machine, a dryer, a refrigerator, a freezer, an oven, a microwave, a dish washer, a furnace, an air conditioner, a television set, or a vacuum cleaner.

6. The process of claims 1 or 2, wherein the coupled propylene polymer is formed by a reaction of a coupling agent with a propylene polymer.

7. The process of claim 6 wherein the coupling agent is a sulfonyl azide.

8. The process of claim 7 wherein the sulfonyl azide is 4,4′-diphenyl ether bis(sulfonyl azide).

9. The process of claim 6 wherein the propylene polymer is an impact propylene copolymer.

10. The process of claims 1 or 2 wherein the coupled propylene polymer composition further comprises a thermoplastic polymer.

11. The process of claims 1 or 2 wherein the thermoplastic polymer is a high crystalline polypropylene homopolymer, a high crystalline polypropylene/ethylene copolymer, a mini-random propylene/ethylene copolymer, a polyethylene, an ethylene-vinyl acetate copolymer, an ethylene-ethyl acetate copolymer or an ethylene acrylic acid.

12. The process of claims 1 or 2 wherein the coupled propylene polymer composition further comprises a filler.

13. The process of claim 12 wherein the filler is talc.

14. The process of claims 1 or 2 wherein the coupled propylene polymer composition further comprises a thermoplastic polymer and a filler.

15. The process of claim 14 wherein the thermoplastic polymer is a high crystalline polypropylene homopolymer and the filler is talc.
